(19) United States
(12) Patent Application Publication
(10) Pub. No.: US 2010/0281849 A1
(43) Pub. Date: Nov. 11, 2010

(54) DOOR-TYPE THRUST REVERSER FOR A JET ENGINE

(75) Inventor: Guy Bernard Vauchel, Harfleur (FR)

Correspondence Address: CANTOR COLBURN, LLP, 20 Church Street, 22nd Floor, Hartford, CT, 06103, US

(73) Assignee: AIRCELLE, GONFREVILLE L'ORCHER (FR)

(21) Appl. No.: 12/811,318

(22) PCT Filed: Oct. 1, 2008
(86) PCT No.: PCT/FR08/01364

§ 371 Date: Jun. 30, 2010

(30) Foreign Application Priority Data
Jan. 8, 2008 (FR) 08/00083

(51) Int. Cl. F02K 3/02

(52) U.S. Cl. 60/226.2

(57) ABSTRACT

This thrust reverser comprises at least two doors (1a, 1b) each able to move between a closed position and an open position. These two doors (1a, 1b) are adjacent and comprise means of mutual immobilization (17, 19) positioned on the adjacent edges of these doors and preventing one of said doors from opening as long as the other is closed.

### TECHNICAL FIELD

The present invention relates to a door-type thrust reverser for a jet engine.

### BACKGROUND

As is known in itself, a door-type thrust reverser comprises, as shown in the appended FIGS. 1 and 2, at least two doors 1a, 1b each mounted pivoting around an axis 3 between a closed position (shown in FIG. 2) corresponding to a normal operation of the jet engine, and an open position (not shown) owing to which the flow of air circulating in the jet 5 can be deviated toward the outside and upstream of the reverser, thereby making it possible to exert a counter-thrust contributing to the braking of the aircraft 7 (upstream and downstream are defined relative to the direction of circulation of the air in the jet engine, from left to right in FIGS. 1 and 2).

In order to secure the opening of the doors 1a, 1b as much as possible and thereby avoid any untimely opening of said doors, at least three independent locking systems are provided for each door.

These three locking systems are generally broken down as follows: a first system locks the upstream portion of each door 1a, 1b, a second system locks the actuating cylinder 9 of said door, and a third system locks a lateral edge of said door.

These three locking systems for each door, often referred to as “lines of defense”, are required by the legislation in force.

Although they make it possible to achieve a very high level of safety, these systems have the drawback of being costly and bulky.

Moreover, a malfunction of the locking system of the cylinder 9 is difficult to detect from the outside, during maintenance operations.

### BRIEF SUMMARY

The present invention aims in particular to resolve these problems.

This aim of the invention is achieved with a thrust reverser comprising at least two doors each able to move between a closed position and an open position, remarkable in that these two doors are adjacent and in that they comprise means of mutual immobilization situated on the adjacent edges of these doors and preventing one of said doors from opening as long as the other is closed.

These means of mutual immobilization form a very simple locking system, making it possible to hold a first door in the closed position owing to a second adjacent door, in the case of breaking of the other two locking systems of that first door.

According to other optional characteristics of the thrust reverser according to the invention:

said means for mutual immobilization are situated on at least one portion of the length of the adjacent edges of said doors;

said means for mutual immobilization comprise a groove situated on the edge of one of said doors, and a blade situated on the adjacent edge of the other door;

said means for mutual immobilization are situated periodically on the adjacent edges of said doors;

said means for mutual immobilization are arranged upstream from said doors;

said means for mutual immobilization comprise a housing situated on the edge of one of said doors, and a slug situated on the adjacent edge of the other door;

said means for mutual immobilization have just enough play to allow the opening of said doors: such play makes it possible, in case of failure of the locking systems of one door, to keep the latter part practically flush with the outer envelope of the nacelle;

said means for mutual immobilization are configured so as to keep said doors integral with each other during part of their opening: this makes it possible, in case of failure of the locking systems of one door, to limit the idle travel of that door during opening of the other door, and thereby to reduce the abutment shock at the end of opening travel of that idle door;

said means for mutual immobilization are integrated into said doors;

said means for mutual immobilization are attached on said doors;

said thrust reverser comprises a beam situated between said doors, extending under said means of mutual immobilization when said doors are closed;

said thrust reverser comprises an actuating cylinder for each door.

The present invention also concerns a nacelle for a jet engine equipped with a thrust reverser according to the preceding.

### BRIEF DESCRIPTION OF THE DRAWINGS

Other characteristics and advantages of the present invention will appear in light of the following description, and upon examination of the appended figures in which:

FIG. 1 illustrates a nacelle for a jet engine, equipped with a door-type thrust reverser according to the prior art, mentioned in the preamble of this description;

FIG. 2 illustrates one of the doors of this thrust reverser of the prior art, seen in longitudinal cross-section,

FIG. 3 is a perspective view of half of a door-type thrust reverser according to the present invention, these doors being in the closed position,

FIG. 4 shows this thrust reverser with its doors open,

FIG. 5 shows a transverse cross-sectional view of this thrust reverser, the doors being in the closed position,

FIG. 6 illustrates a detail view of zone VI of FIG. 5,

FIGS. 7 and 8 are views similar to that of FIG. 6 and correspond to situations where the locking systems of one or the other of the doors have failed, respectively,

FIG. 9 is a view similar to that of FIG. 6, the two doors being shown at the beginning of their opening travel, and

FIG. 10 is a view similar to that of FIG. 6 of another embodiment according to the invention.

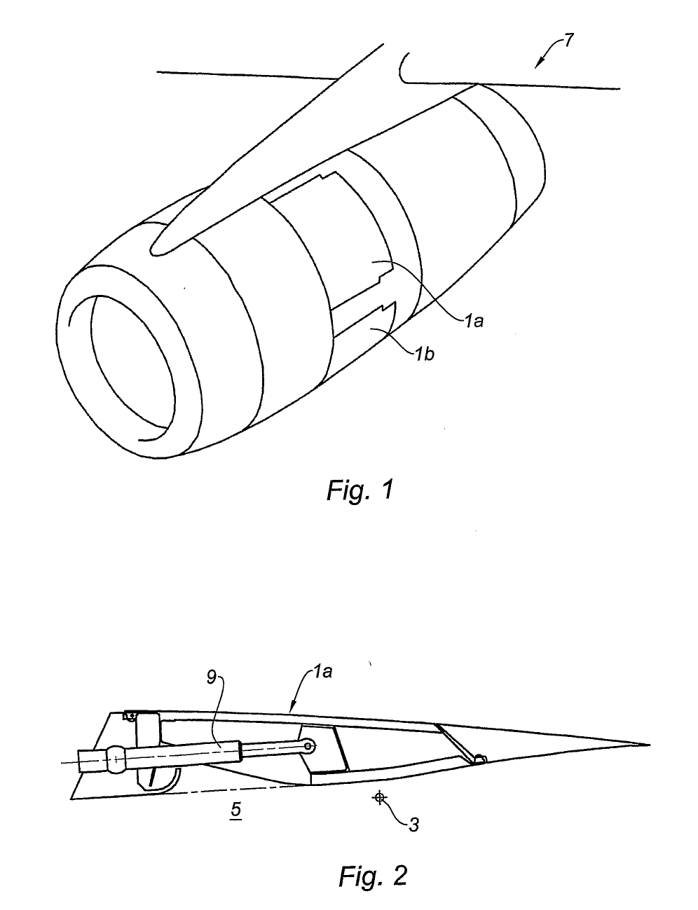

In all of these figures, identical or similar references designate identical or similar members of sets of members.

### DETAILED DESCRIPTION

In reference to FIG. 3, one can see half of a thrust reverser according to the invention, comprising two adjacent doors, 1a and 1b, each mounted pivoting around respective axes 3a and 3b.

In FIG. 3, the two doors 1a, 1b are shown in the closed position: in this position, the adjacent edges 11a, 11b of these two doors cooperate with each other.

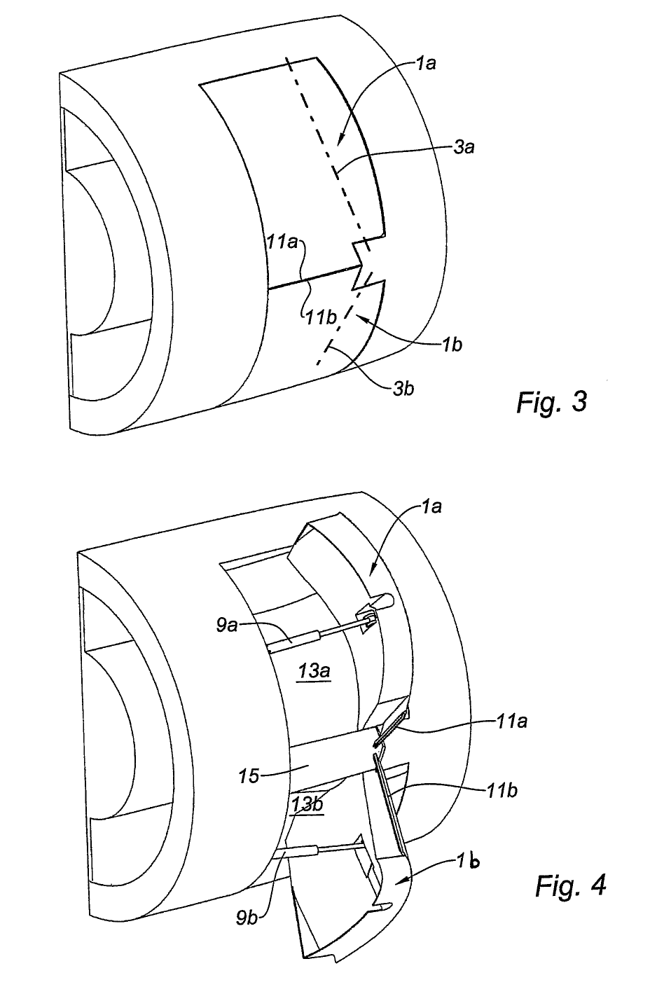

When these two doors are opened under the action of the respective cylinders 9a, 9b, as visible in FIG. 4, the respective edges 11a, 11b of these two doors move away from each other.

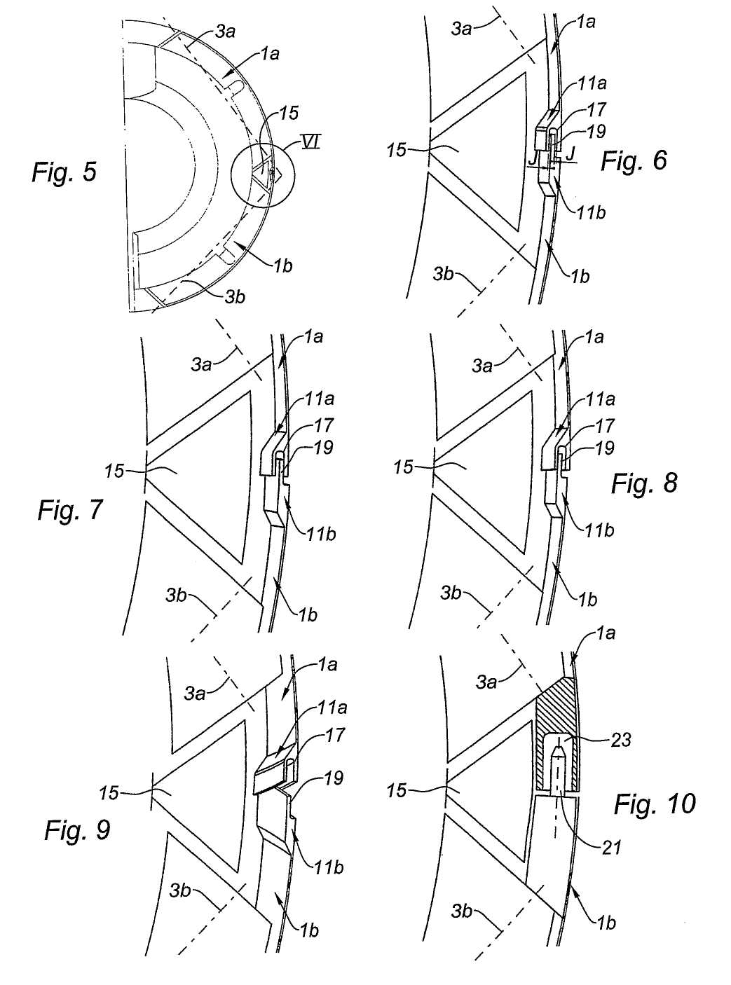

As visible in FIG. 4, the two openings 13a, 13b released by the two doors 1a, 1b, are separated from each other by a longitudinal beam 15, which is covered by the edges 11a, 11b when the doors 1a, 1b are in the closed position (see FIGS. 3 and 5).

In reference more particularly to FIGS. 5 and 6, one can see that the beam 15 can have an essentially trapezoidal section, and that the edges 11a, 11b of the doors 1a, 1b respectively define a groove 17 and a blade 19 inserting itself inside this groove when the doors are in the closed position.

This groove 17 and this blade 19 can be situated locally upstream from the edges 11a, 11b of the doors 1a, 1b, or preferably extend over practically the entire length of these edges.

Play J is provided between each of the face of the blade 19 and the corresponding faces of the groove 17, this play being just enough to allow the blade 19 to come out of the groove 17 upon pivoting of the two doors relative to their respective axes 3a, 3b.

If one assumes that the locking systems of the door 3b become ineffective following an incident such as breaking of fan blades of the engine, this door 3b becomes idle, i.e. free to pivot around its axis 3b.

The blade 19 of the edge 11b of this door 1b then abuts against the radially outer face of housing 17, as shown in FIG. 7.

Now, assuming that it is the door 1a which becomes idle following a failure of its locking systems, then the radially inner face of the housing 17 abuts against the radially inner face of the blade 19, as shown in FIG. 8.

One therefore understands that the blade 19 and the housing 17 constitute means of mutual immobilization of the two doors 1a, 1b, making it possible to retain one or the other of these doors that would become idle following a failure of its locking systems.

This housing 17 and this blade 19 therefore constitute, for each door, a line of defense of extremely simple design, which is added to the other lines of defense constituted by the locking systems of each of these doors.

In FIG. 9 we have shown the two doors 1a, 1b during opening: thanks to the play J illustrated in FIG. 6, the blade 19 can progressively withdraw from the housing 17.

By providing, on one hand, a sufficient circumferential extension for this housing 17 and for this blade 19, and on the other hand, an extension of these two members over practically the entire length of the edges 11a, 11b of the doors 1a, 1b, one can act such that the complete release of the blade 19 from the housing 17 only takes place at the end of the opening travel of the two doors.

This particular arrangement makes it possible to ensure that a door becoming idle following a failure of its locking systems can only detach from its adjacent door when these two doors arrive practically at the end of opening travel, thereby minimizing the abutment shock upon opening of the idle door.

FIG. 10 illustrates another embodiment of the invention, in which the mutual immobilization of the doors 1a and 1b is obtained using a slug 21 cooperating with a housing 23, these members being situated preferably near the upstream end of the doors 1a, 1b.

One will note that, in addition to the great simplicity of the immobilization obtained by the arrangement according to the invention, providing that the edges 11a, 11b circumferentially overhang the body of the doors 1a, 1b, as visible in all of FIGS. 4 to 9, makes it possible to increase the wind resistance of these doors when they are in the open position, which contributes to the braking action of the aircraft.

Of course, the present invention is in no way limited to the embodiments described and illustrated, provided as simple examples.

It is in this way for instance that the principle of doors mutually immobilizing each other in the closed position could be extended to more than two doors, for example three or four doors mutually cooperating with each other.

1. A thrust reverser comprising:
at least two doors each able to move between a closed position and an open position,
wherein the two doors are adjacent and comprise means for mutual immobilization situated on adjacent edges of the doors and preventing the opening of one of said doors as long as the other is closed.

2. The thrust reverser according to claim 1, wherein said means for mutual immobilization are situated on at least part of a length of the adjacent edges of said doors.

3. The thrust reverser according to claim 2, wherein said means for mutual immobilization comprise a groove situated on the edge of one of said doors, and a blade situated on the adjacent edge of the other door.

4. The thrust reverser according to claim 1, wherein said means for mutual immobilization are situated periodically on adjacent edges of said doors.

5. The thrust reverser according to claim 4, wherein said means for mutual immobilization are arranged upstream from said doors.

6. The thrust reverser according to claim 4, wherein said means for mutual immobilization comprise a housing situated on the edge of one of said doors, and a slug situated on the adjacent edge of the other door.

7. The thrust reverser according to claim 1, wherein said means for mutual immobilization have just enough play to allow the opening of said doors.

8. The thrust reverser according to claim 1, wherein said means for mutual immobilization are configured so as to keep said doors integral with each other during part of their opening.

9. The thrust reverser according to claim 1, wherein said means for mutual immobilization are integrated into said doors.

10. The thrust reverser according to claim 1, wherein said means for mutual immobilization are attached on said doors.

11. The thrust reverser according to claim 1, wherein said thrust reverser comprises a beam situated between said doors, extending under said means of mutual immobilization when said doors are closed.

12. The thrust reverser according to claim 1, wherein said thrust reverser comprises an actuating cylinder for each door.

13. A nacelle for a jet engine, comprising a thrust reverser according to claim 1.
